(19) United States
(12) Patent Application Publication
(10) Pub. No.: US 2011/0187670 A1
(43) Pub. Date: Aug. 4, 2011

(54) TOUCH PANEL

(75) Inventors: Yu-Chou YEH, Taoyuan County (TW); Hsiao-Shun Jan, Taoyuan County (TW)

(73) Assignee: J TOUCH CORPORATION, Taoyuan County (TW)

(21) Appl. No.: 12/755,530

(22) Filed: Apr. 7, 2010

(30) Foreign Application Priority Data
Feb. 3, 2010 (TW) 099103193

(51) Int. Cl. G06F 3/045

(52) U.S. Cl. 345/174

(57) ABSTRACT

A touch panel having a touch sensing layer comprises a first transparent electrically conductive film and a second transparent electrically conductive film, each being provided with a plurality of first sensing electrodes and a plurality of second sensing electrodes, moreover, first circuits, second circuits, first inserting ends, second inserting ends and first connecting ends being provided on the first transparent electrically conductive film, and second connecting ends being provided on any sides of the second sensing electrodes on the second transparent electrically conductive film. When the first transparent electrically conductive film and the second transparent electrically conductive film are adhered to each other, the first connecting ends can exactly contact the corresponding second connecting ends. After adhesion, the first inserting ends and the second inserting ends can be exposed outside. Thus, testing procedure can be facilitated.

### BACKGROUND OF THE INVENTION

1. Field of the Invention

The present invention relates to a touch panel, and more particularly to a touch panel capable of rapidly detecting the yield to reduce the production costs without the combination of other modules or the use of other sophisticated testing methods.

2. Description of the Related Art

Common types of touch panels include a resistance type, a capacitance type, an ultrasonic wave type, an optical (infrared) type, and the like. Among them, resistance-type touch panels are the most widely used, and capacitance-type touch panels are the second most widely used.

A conventional touch panel has at least two PET substrates, and touch sensing layers are provided on the corresponding surfaces of the PET substrates. Referring to FIG. 1, it illustrates a schematic exploded view of and a schematic view of the assembly of a conventional touch sensing layer. It should be noted that the description herein is directed to the circuit layout and structure of a touch sensing layer 1. Therefore, a first electrically conductive film 11 and a second electrically conductive film 12 should be adhered to each other with an optically clear adhesive and structures such as transparent substrates and the like are also provided on the upper and lower surfaces thereof and will be explained in no more detail.

As illustrated in this figure, a conventional touch sensing layer 1 has a first electrically conductive film 11 and a second electrically conductive film 12. Y-axis sensing electrodes 111 and Y-axis inserting ends (generally known as goldfingers) 113 are respectively provided on the first electrically conductive film 11, and the Y-axis sensing electrodes 111 are electrically connected with the Y-axis inserting ends 113 via Y-axis circuits 112. As same as the first electrically conductive film 11, X-axis sensing electrodes 121, X-axis circuits 122 and X-axis inserting ends 123 are also respectively provided on the second electrically conductive film 12. Generally, the first electrically conductive film 11 and the second electrically conductive film 12, which serve as upper and lower electrically conductive films, are adhered to each other with an optically clear adhesive. They may be adhered with their faces, on which the sensing electrodes and the circuits are provided, toward the same direction (for example, together toward the upper direction or together toward the lower direction), or may be adhered with the faces opposing to each other. The difference between the first electrically conductive film 11 and the second electrically conductive film 12 is that the Y-axis inserting ends 113 are provided at the central position of the lower portion of the first electrically conductive film 11 but the X-axis inserting ends 123 are provided on two sides of the lower portion of the second electrically conductive film 12. After the first electrically conductive film 11 and the second electrically conductive film 12 are overlapped with each other, the Y-axis inserting ends 113 and the X-axis inserting ends 123 are aligned to each other and arranged at immediately lower portions of the first electrically conductive film 11 and the second electrically conductive film 12 in a uniform distribution manner.

During the testing stage for a touch panel in the subsequent process, parts or all of the inserting ends are adhered inside the electrically conductive films after adhesion and cannot be used for testing purposes, so a flexible printed circuit (FPC) board, along with the first electrically conductive film and the second electrically conductive film must be adhered together to perform testing on the touch panel. However, if the touch panel is detected as defective after the electrically conductive films as well as the flexible printed circuit board have been adhered together, the flexible printed circuit board must be scrapped with the touch panel and cannot be reused. This results in waste of components and difficulty in testing a panel. For a panel with the aforementioned faces toward the same direction, the lower portions of the electrically conductive films where no inserting ends are provided may be hollowed out. For example, two sides by the Y-axis inserting ends 113 of the first electrically conductive film 11 may be hollowed out, and the central portion between the X-axis inserting ends 123 of the second electrically conductive film 12 may also be hollowed out. When the first electrically conductive film 11 and the second electrically conductive film 12 are adhered to each other, the inserting ends of each electrically conductive film can be exactly exposed outside for direct testing. But, for a touch panel with the aforementioned faces toward the same direction, an additional arrangement of a protective layer or an insulating layer is required to protect the circuits and the electrodes. Even if the above-described processing has been carried out, many current touch panels, in which the aforementioned faces must be adhered to each other in an opposing direction due to elimination of the stacked structure or according to the requirements of product design, still cannot be directly tested. They must be turned over up and down for testing, or a testing fixture is particularly designed for such structures.

### SUMMARY OF THE INVENTION

In view of the above demands, the invertors design a touch panel after conducting elaborate research and with accumulated years of experience in this field.

It is an object of the present invention to provide a touch panel, which is good for testing purposes.

It is an object of the present invention to provide a touch panel capable of performing detection without the combination of additional and other components.

It is an object of the present invention to provide a touch panel with no need to use a special testing method and to manufacture a special testing apparatus.

To achieve the foregoing objects, a touch panel according to the present invention has a touch sensing layer. It should be noted that the touch sensing layer also includes therewithin an optically clear adhesive layer on whose upper and lower surfaces are disposed transparent substrates, image layers, and other multilayer structures, etc. However, such multilayer structures are not the appeals of the invention and belong to conventional technologies which have been disclosed, and therefore, will be explained in no more detail.

The touch sensing layer comprises a first transparent electrically conductive film and a second transparent electrically conductive film, each being provided with a plurality of first sensing electrodes and a plurality of second sensing electrodes, first circuits and second circuits being provided on the first transparent electrically conductive film, wherein one end of the first circuit is electrically connected with the first sensing electrode, the other end thereof is connected with a first inserting end, and the plurality of first inserting ends are disposed at the lower position of the first transparent electrically conductive film in a uniform distribution manner. Moreover, a plurality of second circuits are provided on the first transparent electrically conductive film, wherein one end of the second circuit is connected to a first connecting end, the other end thereof is connected to a second connecting end, and the plurality of second inserting ends are disposed at the lower position of the first transparent electrically conductive film and at the same horizontal position of the first inserting ends in a uniform distribution manner so that the plurality of first inserting ends and the plurality of second inserting ends can be disposed in a row. In addition, a plurality of second sensing electrodes and a plurality of second connecting ends are provided on the second transparent electrically conductive film, wherein the second connecting end is respectively electrically connected with one end of the second sensing electrode and the above-described first connecting ends are provided at the same positions corresponding to the second connecting ends. When the first transparent electrically conductive film and the second transparent electrically conductive film are adhered to each other in an opposing direction, the first connecting ends exactly contact the corresponding second connecting ends so that the second sensing electrodes are thus electrically connected with the second circuits and the second inserting ends. After the two electrically conductive films are adhered together, the first inserting ends and the second inserting ends on the first transparent electrically conductive film can be exposed outside. It is convenient that the touch panel is directly electrically connected with a testing fixture for testing.

### BRIEF DESCRIPTION OF THE DRAWINGS

FIG. 1 is a schematic exploded view of a conventional touch sensing layer.

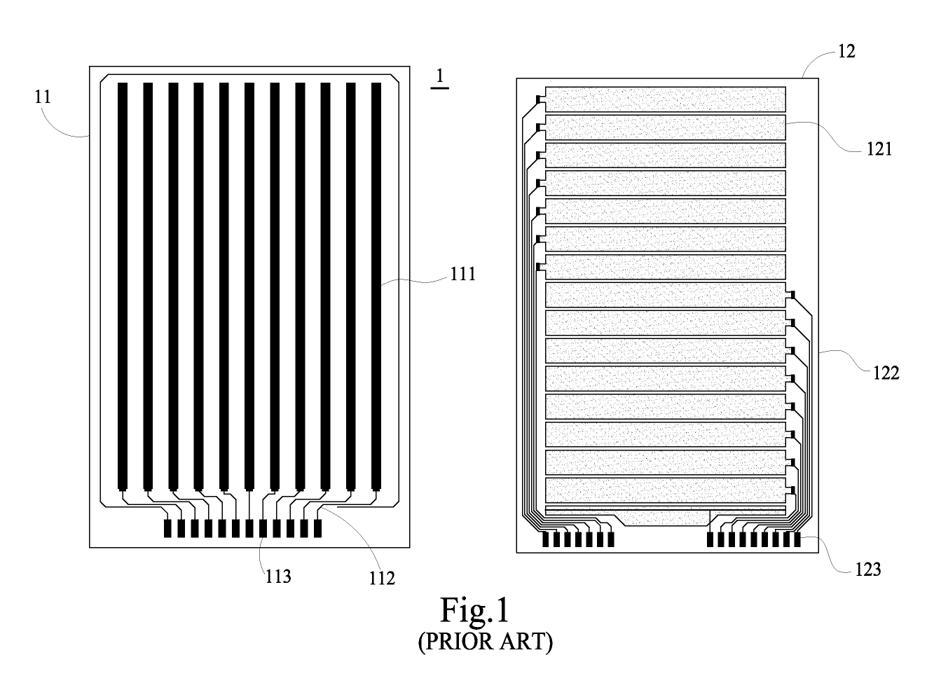

FIG. 2 is a schematic view of a preferred embodiment according to the present invention.

FIG. 3 is a schematic view of the assembly of another preferred embodiment according to the present invention.

FIG. 4 is a schematic view of the assembly according to the present invention.

### DETAILED DESCRIPTION OF THE PREFERRED EMBODIMENTS

The contents of the present invention will become more apparent from the following description when taken in conjunction with the drawings.

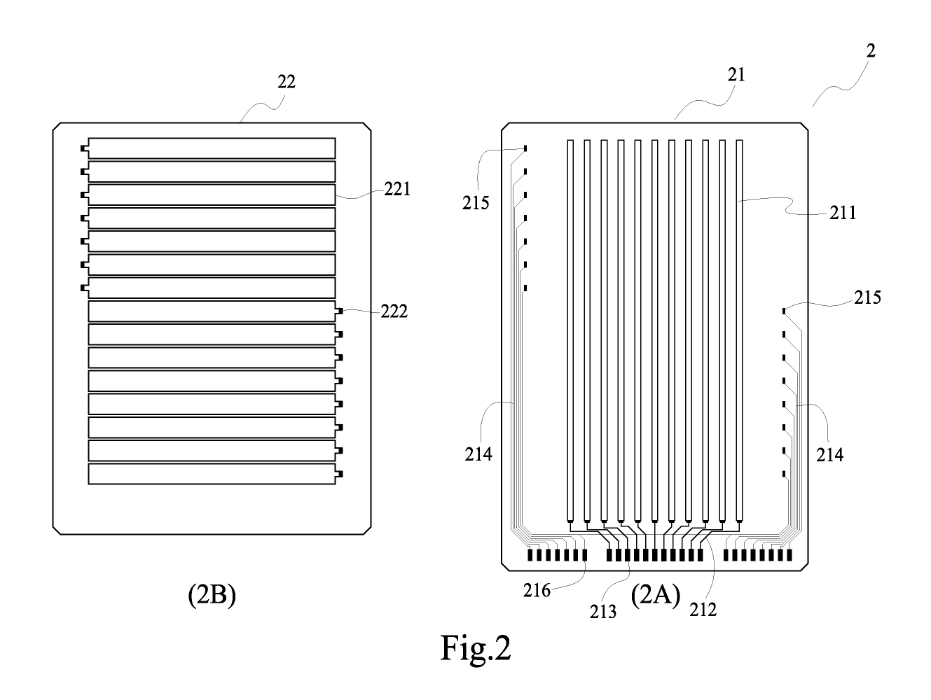

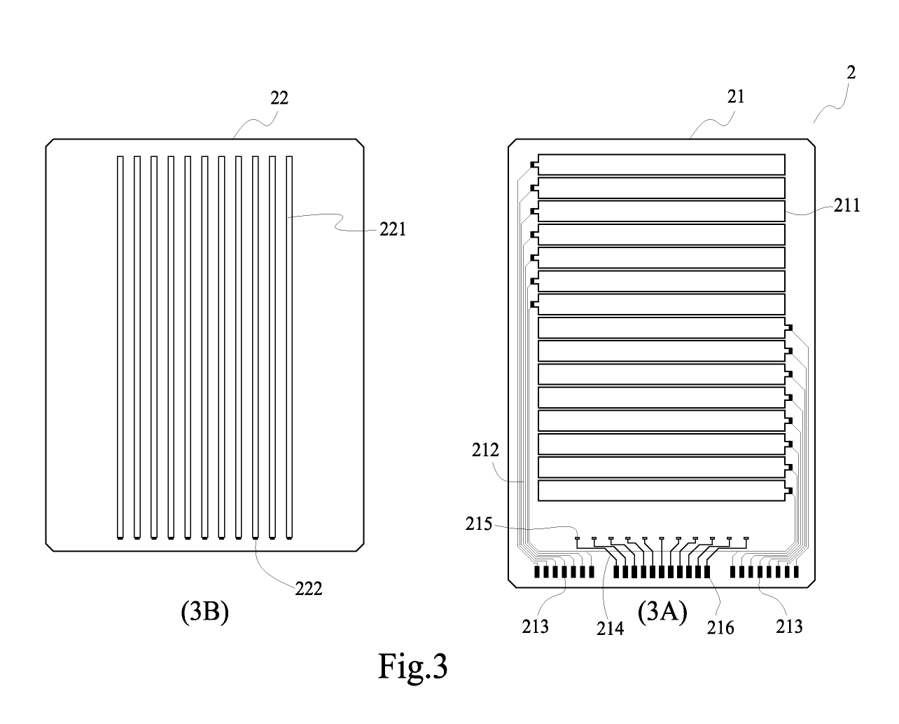

Referring to FIGS. 2 and 3, there are illustrated schematic views of a preferred embodiment and the assembly of another preferred embodiment according to the present invention. As illustrated in these figures, the touch panel has a touch sensing layer 2. It should be noted that the touch sensing layer 2 also includes therewithin an adhesive layer, generally an optically clear adhesive (OCA) layer, on whose upper and lower surfaces are disposed transparent substrates, image layers, and other multilayer structures, etc. However, such multilayer structures are not the appeals of the invention and belong to conventional technologies which have been disclosed, and therefore, will be explained in no more detail.

The touch sensing layer 2 comprises a first transparent electrically conductive film 21 and a second transparent electrically conductive film 22. The transparent electrically conductive films comprise a material selected from one of the impurity-doped oxides group consisting of indium tin oxide (ITO), indium zinc oxide (IZO), Al-doped ZnO (AZO) and antimony tin oxide (ATO).

The first transparent electrically conductive film 21 is provided with a plurality of first sensing electrodes 211, which may be arranged in a horizontal direction (also referred to as the X-direction) or in a vertical direction (also referred to as the Y-direction) on the first transparent electrically conductive film 21. Furthermore, a plurality of first inserting ends 213 and a plurality of second inserting ends 216 are provided on any side of the first transparent electrically conductive film 21. The first sensing electrodes 211 are respectively electrically connected to the first inserting ends 213 via first circuits 212, and the second inserting ends 216 are respectively connected to a plurality of first connecting ends 215 via second circuits 214. The first connecting ends 215 are provided on the periphery of the first transparent electrically conductive film 21 and have no contact with the first sensing electrodes 211.

The second transparent electrically conductive film 22 is provided with a plurality of second sensing electrodes 221, which may be arranged in a horizontal direction (also referred to as the X-direction) or in a vertical direction (also referred to as the Y-direction) on the second transparent electrically conductive film 22. Furthermore, a plurality of second connecting ends 222 are provided on any sides of the second sensing electrodes 221. The above-described first connecting ends 215 on the first transparent electrically conductive film 21 are provided at the same positions corresponding to the second connecting ends 222. After the first transparent electrically conductive film 21 and the second transparent electrically conductive film 22 are adhered to each other in an opposing direction, the first connecting ends 215 can exactly contact the corresponding second connecting ends 222 respectively so that the second sensing electrodes 221 on the second transparent electrically conductive film 22 are thus electrically connected with the second circuits 214 and the second inserting ends 216 on the first transparent electrically conductive film 21. In such structures, all of the circuits and the inserting ends (generally known as goldfingers) are fabricated on one electrically conductive film of the touch panel, and no circuits or inserting ends are provided on the other electrically conductive film except X-axis or Y-axis sensing electrodes. Instead, only a connecting end made of electrically conductible metal material is provided on one end of each sensing electrode (as illustrated in FIGS. 2B and 3B) so that these connecting ends can be contacted and conducted with the connecting ends at the same positions on the other electrically conductive film. In such manner, all of the inserting ends can be arranged on the same side face. It is convenient that the touch panel is connected to a testing fixture for testing.

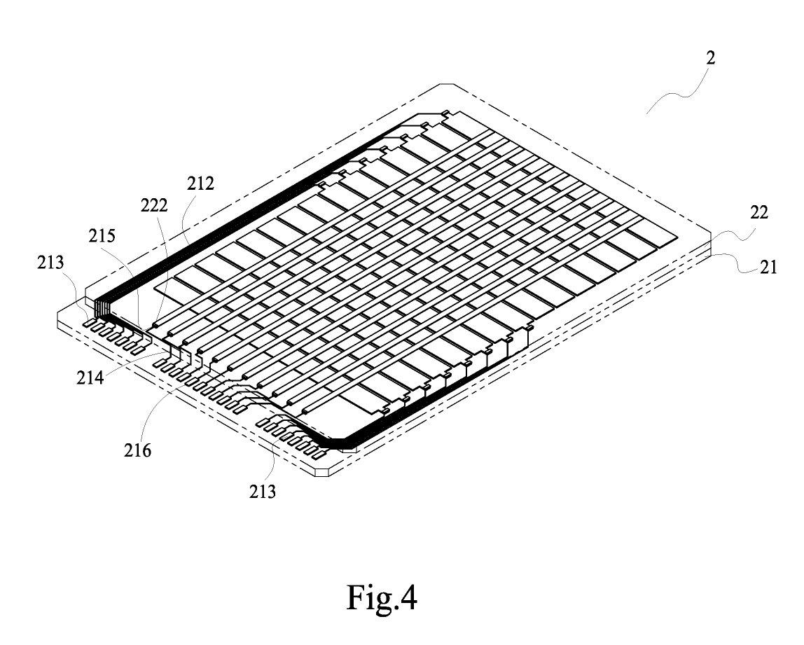

Referring to a schematic view of the assembly according to the present invention illustrated in FIG. 4, in order that the first inserting ends 213 and the second inserting ends 216 can be exposed outside for the convenience of direct electrical connection to perform testing after the first transparent electrically conductive film 21 and the second transparent electrically conductive film 22 are adhered together, the size of the second transparent electrically conductive film 22 may be a bit smaller than that of the first transparent electrically conductive film 21.

The first circuits 212 and second circuits 214 as well as the first connecting ends 215 and second connecting ends 222 are made of one selected from chromium, aluminium, silver, molybdenum, copper, gold, and high conductivity metals and alloy materials.

The first inserting ends 213 and the second inserting ends 216 are arranged at one of the left edge, the right edge, the upper edge and the lower edge of the first transparent electrically conductive film 21. The first inserting ends 213 may be provided at the central portion (or on two sides) of an edge of the electrically conductive film so that the second inserting ends 216 are arranged on two sides (or at the central portion) of an edge thereof, as illustrated in FIGS. 2A and 3A. However, the present invention is not limited to such an arrangement. The first inserting ends 213 and the second inserting ends 216 may also be provided respectively on left and right sides of an edge of the electrically conductive film.

It should be noted that each drawing in this embodiment is represented in a top view, and therefore the present invention is not limited to the hierarchic order of stacking the first transparent electrically conductive film 21 on the second transparent electrically conductive film 22 or stacking the second transparent electrically conductive film 22 on the first transparent electrically conductive film 21.

However, what are described above are only preferred embodiments of the invention and should not be used to limit the claims of the present invention; the above description can be understood and put into practice by those who are skilled in the present technical field, and therefore all equivalent changes and modifications made without departing from the spirit and scope of the present invention should be included in the appended claims.

In summarization of the foregoing description, the touch panel according to the present invention meets the requirements of inventiveness and industrial applicability of patents. Therefore, the application for a patent is duly filed accordingly.

What is claimed is:

1. A touch panel, having a touch sensing layer, the touch sensing layer comprising:
a first transparent electrically conductive film provided with a plurality of first sensing electrodes, a plurality of first inserting ends being provided on one side of the first transparent electrically conductive film, the first sensing electrodes being respectively electrically connected to the first inserting ends via first circuits, a plurality of second inserting ends being provided on the first transparent electrically conductive film and on the same side of the first inserting ends, the second inserting ends being respectively electrically connected to a plurality of first connecting ends via second circuits; and
a second transparent electrically conductive film provided with a plurality of second sensing electrodes, a plurality of second connecting ends being provided on one side of the second transparent electrically conductive film, wherein the first connecting ends on the first transparent electrically conductive film are provided at the same positions corresponding to the second connecting ends.

2. The touch panel as set forth in claim 1, wherein the first transparent electrically conductive film and the second transparent electrically conductive film are adhered to each other in an opposing direction with an adhesive layer.

3. The touch panel as set forth in claim 2, wherein the adhesive layer is an optically clear adhesive (OCA) layer.

4. The touch panel as set forth in claim 2, wherein the first connecting ends correspondingly contact the second connecting ends respectively after the first transparent electrically conductive film and the second transparent electrically conductive film are adhered together.

5. The touch panel as set forth in claim 2, wherein the first inserting ends and the second inserting ends are exposed outside after the first transparent electrically conductive film and the second transparent electrically conductive film are adhered together.

6. The touch panel as set forth in claim 1, wherein the first inserting ends and the second inserting ends are arranged at one of the left edge, the right edge, the upper edge and the lower edge of the first transparent electrically conductive film.

7. The touch panel as set forth in claim 1, wherein the first transparent electrically conductive film and the second transparent electrically conductive film comprise a material selected from one of the impurity-doped oxides group consisting of indium tin oxide (ITO), indium zinc oxide (IZO), Al-doped ZnO (AZO) and antimony tin oxide (ATO).

8. The touch panel as set forth in claim 1, wherein the first sensing electrodes and the second sensing electrodes cross each other at right angles.

9. The touch panel as set forth in claim 1, wherein the first circuits and the second circuits are made of one selected from chromium, aluminium, silver, molybdenum, copper, gold, and high conductivity metals and alloy materials.

10. The touch panel as set forth in claim 1, wherein the first connecting ends and the second connecting ends are made of one selected from chromium, aluminium, silver, molybdenum, copper, gold, and high conductivity metals and alloy materials.
